(19) United States
(12) Patent Application Publication
(10) Pub. No.: US 2014/0260761 A1
(43) Pub. Date: Sep. 18, 2014

(54) METHOD AND SYSTEM FOR STOWING STEERING COLUMN IN A VEHICLE

(71) Applicant: FORD GLOBAL TECHNOLOGIES, LLC, Dearborn, MI (US)

(72) Inventor: Erik William Soderlind, Harrison Twp., MI (US)

(73) Assignee: Ford Global Technologies, LLC, Dearborn, MI (US)

(21) Appl. No.: 13/848,097

(22) Filed: Mar. 21, 2013

Related U.S. Application Data
(60) Provisional application No. 61/791,929, filed on Mar. 15, 2013.

(51) Int. Cl. B62D 1/18

(52) U.S. Cl. CPC B62D 1/18
USPC 74/493

(57) ABSTRACT

A stowing steering column is provided that is capable of a high range of travel at a high rate of speed. The stowing steering column includes a roof bracket for attachment to the instrument panel, a sleeve attached to the bracket, a steering column shaft attached to the sleeve, and a steering wheel fitted to the shaft. The powered steering shaft preferably has a stowing travel range of between about +90 mm and +110 mm from mid-line and a travel speed of between about 20 mm/sec and 40 mm/sec. The stowing range of travel between about +90 and +110 mm is in addition to the functional vehicle-inward movement of +25 mm. This wide range of travel and high speed movement allows for quick positioning and re-positioning of the steering wheel. Optionally the instrument panel includes a steering-wheel receiving pocket into which the steering wheel will nest when in its retracted position.

### CROSS-REFERENCE TO RELATED APPLICATION

This application claims the benefit of U.S. Provisional Patent Application Ser. No. 61/791,929 filed Mar. 15, 2013, incorporated herein by reference in its entirety.

### TECHNICAL FIELD

The disclosed invention relates generally to vehicle steering columns. More particularly, the disclosed invention relates to a steering column for a vehicle that can be axially translated to a given forward distance so that a driver might perceive an increase in vehicle roominess upon first entering the vehicle.

### BACKGROUND OF THE INVENTION

Movable steering wheels and steering columns have been features of the automobile industry almost since its very beginning. For example, because of limited space between the steering wheel of the Model T and the seat back and base accessory steering wheels were made available by after-market manufacturers that could be release and swung out of the driver's way upon entering and exiting the driver's seat. Later vehicles included steering columns that could be pivotably adjusted by a small amount to allow greater clearance for the driver between the steering wheel and the driver's seat.

Frequently, as in the case of the movable steering wheel accessory mentioned above, movement of the steering wheel is thought desirable, perhaps necessary, to allow some people to position themselves between the driver's seat and the steering wheel. In such instances movement of the steering wheel is done for practical reasons.

However, in other cases, it is desirable to move the steering wheel forward to the instrument panel to give the appearance of a larger vehicle interior as is often the case with today's increasingly popular smaller vehicle. This impression is particularly important in the vehicle showroom where the potential purchaser may be viewing the vehicle for the first time. In such circumstances the roomier appearance of the vehicle may be more favorably viewed by the driver and potential purchaser.

A number of constraints exist on movement of the steering wheel given passenger safety standards and packaging. With respect to occupant safety, considerations include crash loads (overturning moment) and load vs. displacement selections and the size and configuration of the internal steering components of the steering column. Particularly challenging in the design of an axially movable steering column is the need to separate the stowing or functional travel mechanism from the crash stroking plane.

Known systems for applying axial movement to the steering column fail to overcome the challenges faced both in terms of safety and of packaging. Such systems are limited to a typical axial travel of only about +25 mm to either side of mid-line at a rate of about between about 10 and 20 mm/sec, making such systems impractical for use in stowing the steering column while the driver is out of the seat then extending the column quickly after the driver is seated.

As in so many areas of vehicle technology there is always room for improvement related to stowable steering columns.

### SUMMARY OF THE INVENTION

The disclosed invention overcomes several of the problems of the prior art by providing a stowing steering column that is capable of a high range of travel at a high rate of speed. The stowing steering column of the disclosed invention includes a roof bracket for attachment to the instrument panel, a sleeve attached to the bracket, and a steering column shaft movably attached to the sleeve. A steering wheel is fitted to an end of the steering column shaft.

The steering column shaft has a stowing travel range of between about +90 mm and +110 mm and a travel speed of between about 20 mm/sec and 40 mm/sec, or roughly double known rates. The stowing range of travel between about +90 mm and +110 mm is in addition to the functional vehicle-inward movement of +25 mm from mid-line.

The stowing steering column further includes a motor for axially adjusting the steering column shaft relative to the steering column sleeve.

The sleeve is pivotably attached to the roof bracket. The column further includes a steering column bracket extending from the roof bracket to which the steering column shaft is attached whereby the steering column bracket is adjustably movable with respect to the roof bracket. Optionally a motor may be provided for adjustably moving the steering column bracket with respect to the roof bracket.

The instrument panel is formed to define a steering-wheel receiving pocket into which the steering wheel will nest when in its retracted position. One or more sensors are provided for determining the position of the steering wheel relative to the instrument panel. The sensor may be selected from the group consisting of a hall current sensor, a potentiometer sensor, and a feedback sensor.

The above advantages and other advantages and features will be readily apparent from the following detailed description of the preferred embodiments when taken in connection with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention wherein:

FIG. 1 shows a perspective view of a stowing steering column according to the disclosed invention;

FIG. 2 illustrates a side view of components of the stowing steering column of the disclosed invention;

FIG. 3 illustrates a side view of the stowing steering column of the disclosed invention with the steering wheel in its extended, operating position;

FIG. 4 illustrates a side view of the stowing steering column of the disclosed invention with the steering wheel in its retracted, stowed position; and

FIG. 5 is a front view of an instrument panel according to the disclosed invention that includes a recessed, steering wheel-receiving area.

### DETAILED DESCRIPTION OF THE PREFERRED EMBODIMENT

In the following figures, the same reference numerals will be used to refer to the same components. In the following description, various operating parameters and components are described for different constructed embodiments. These specific parameters and components are included as examples and are not meant to be limiting.

In general, the disclosed invention provides a stowing steering column that is movable between a extended position for driver use and a retracted or stowed position when the driver is not present. With reference to FIG. 1, a perspective view of a stowing steering column, generally illustrated as 10, according to the disclosed invention is illustrated. The stowing steering column 10 includes a steering wheel 12, a cover or shroud 14, and a roof bracket 16 for attachment to the underside of an instrument panel. It is to be understood that the illustrated configurations of the stowing steering column 10 are for illustrative purposes only and that other shapes may be adopted without deviating from the spirit and scope of the disclosed invention.

FIG. 2 illustrates a side view of components of the stowing steering column 10 of the disclosed invention with the cover or shroud 14 having been removed. The roof bracket 16 includes an extension arm 18. A shaft sleeve or shaft bracket 20 is pivotably attached to the extension arm 18 at a pivot assembly 22.

A powered steering shaft 24 is axially and movably provided within the shaft sleeve or shaft bracket 20. A drive motor support bracket 26 is provided in association with the shaft sleeve or shaft bracket 20. A drive motor 28 is operatively associated with the steering shaft sleeve 26.

The powered steering shaft 24 preferably has a stowing travel range of between about +90 mm and +110 mm and a travel speed of between about 20 mm/sec and 40 mm/sec. As noted above, the stowing range of travel between about +90 and +110 mm is in addition to the functional vehicle-inward movement of +25 mm from the mid-line. This wide range of travel and high speed movement allows for quick positioning and re-positioning of the steering wheel 12 as required for a given situation. Both degree of travel and speed of travel may be driver-adjusted according to personal preferences.

The powered steering shaft 24 may be splined or otherwise configured so as to allow operative engagement of the drive motor 28. Operation of the drive motor 28 allows the axial movement of the powered steering shaft 24 with respect to the shaft sleeve or shaft bracket 20.

The height of the steering wheel 12 (shown in FIG. 1) may be adjusted based on the comfort and practical requirements of the driver. A shaft bracket 30 is fitted to the powered steering shaft 24. The powered steering shaft 24 allows the shaft bracket 30 to rotate therein. The shaft bracket 30 is movably attached to a U-shaped bracket 32 that extends downwardly from the roof bracket 16. Horizontal adjustment of the powered steering shaft 24 is made by movement up or down of the shaft bracket 30 within the U-shaped bracket 32. Movement may be made manually or by an elevation adjustment motor 34.

The steering wheel 12 of the disclosed invention is selectively movable between an extended or in-use position when the driver is present and a stowed position when the driver is not present. A sensor provided in the driver's seat may be used to detect presence or absence of the driver from the driver's seat as is known in the art.

FIGS. 3 and 4 illustrate side views of the stowing steering column 10 between its extended, in-use position and its stowed position. In both figures an instrument panel 36 is illustrated having an optional recessed, steering wheel-receiving area 38.

As illustrated in FIG. 3, the steering wheel 12 and the cover or shroud 14 are spaced apart from the instrument panel 36. This is the position necessary for the driver to operate the vehicle.

As illustrated in FIG. 4, the steering wheel 12 and the cover or shroud 14 are now in the stowed position and are close in relation to the instrument panel 36. This is the position that would be suitable to allow easy ingress and egress for the driver into and out of the driver's seat.

A steering shaft position sensor 40 is provided in relation to the stowing steering column 10. The steering shaft position sensor 40 is used to determine the position of the powered steering shaft 24. The steering shaft position sensor 40 is operatively associated with the seat/column sensor provided in association with the driver's seat and, operating in conjunction with the drive motor 28, functions to assure that the powered steering shaft 24 is in the correct position for a given operating situation. The steering shaft position sensor 40 may be of any suitable type of sensor but may be selected from the group consisting of a hall current sensor, a potentiometer sensor, and a feedback sensor.

As noted above, optionally the steering wheel 12 may substantially nest within the optional recessed, steering wheel-receiving area 38 of the instrument panel 36. The recessed, steering wheel-receiving area 38 is illustrated particularly in FIG. 5. The shape and overall configuration of the recessed, steering wheel-receiving area 38 illustrated herein is suggestive and is not intended as being limiting.

Other features of the disclosed invention may be incorporated such as providing instrumentation either in relation to a multi-function switch stalk 42 (shown in FIGS. 3 and 4), to the steering wheel 12, or to both. Such steps may be necessary to allow for proper stowing of the steering wheel 12.

In operation, the steering wheel 12 would normally be in its stowed position as illustrated in FIG. 4 when the vehicle is off (ignition key is removed) or when no driver is detected in the driver's seat. By having the steering wheel 12 in its stowed position an appearance of openness is created within the interior of the vehicle. Once the driver is seated in the driver's seat and the ignition is turned on the drive motor 28 is engaged and the steering wheel 12 is moved quickly to its extended, in-use position as shown in FIG. 2.

The position of the powered steering shaft 24 is determined by the steering shaft position sensor 40. When the powered steering shaft 24 has been extended to its in-use position the axial movement of the powered steering shaft 24 caused by the drive motor 28 is stopped.

When the vehicle ignition is turned off (ignition key removed) the drive motor 28 is again engaged and the powered steering shaft 24 is moved away from the driver toward its stowed position. When the steering shaft position sensor 40 determines that the powered steering shaft 24 is in its proper position the axial movement of the powered steering shaft 24 caused by the drive motor 28 is stopped

As an alternative to the arrangement described above, the driver may manipulate an ignition switch or button (such as an ignition button) to thereby engage the drive motor 28 to thereby move the steering wheel 12 vehicle forward into its stowed position. The steering wheel 12 would remain in its stowed position until the driver again manipulates the ignition switch or button to its off position.

The foregoing discussion discloses and describes exemplary embodiments of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A stowing steering column for a vehicle having an instrument panel comprising:
a roof bracket for attachment to the instrument panel;
a sleeve attached to said bracket;
a steering column shaft movably attached to said sleeve, said steering column shaft having a stowing range of travel between about +90 mm and +110 mm from mid-line and a travel speed of between about 20 mm/sec and 40 mm/sec.

2. The stowing steering column for a vehicle of claim 1 further including a motor for axially adjusting said steering column shaft relative to said steering column sleeve.

3. The stowing steering column for a vehicle of claim 1 whereby said sleeve is pivotably attached to said roof bracket.

4. The stowing steering column for a vehicle of claim 1 further including a steering column bracket extending from said roof bracket to which said steering column shaft is attached.

5. The stowing steering column for a vehicle of claim 4 wherein said steering column bracket is adjustably movable with respect to said roof bracket.

6. The stowing steering column for a vehicle of claim 1 further including a motor for adjustably moving said steering column bracket with respect to said roof bracket.

7. The stowing steering column for a vehicle of claim 1 further including a steering wheel fitted to an end of said steering column shaft.

8. The stowing steering column for a vehicle of claim 7 further including a sensor for determining the position of said steering wheel relative to the instrument panel.

9. The stowing steering column for a vehicle of claim 8 wherein said sensor is selected from the group consisting of a hall current sensor, a potentiometer sensor, and a feedback sensor.

10. A stowing steering arrangement for a vehicle comprising:
an instrument panel;
a steering column having an axially movable steering column shaft and a steering wheel attached to said shaft, said steering column shaft having a stowing range of travel between about +90 mm and +110 mm from mid-line and a travel speed of between about 20 mm/sec and 40 mm/sec; and
a steering wheel-receiving pocket defined in said instrument panel.

11. The stowing steering arrangement for a vehicle of claim 10 further including a roof bracket for attachment to said instrument panel and a sleeve attached to said bracket, said a steering column shaft being movably attached to said sleeve.

12. The stowing steering arrangement for a vehicle of claim 11 further including a motor for axially adjusting said steering column shaft relative to said steering column sleeve.

13. The stowing steering arrangement for a vehicle of claim 11 whereby said sleeve is pivotably attached to said roof bracket, said arrangement further including a steering column bracket extending from said roof bracket to which said steering column shaft is attached.

14. The stowing steering arrangement for a vehicle of claim 11 wherein said steering column bracket is adjustably movable with respect to said roof bracket, said arrangement further including a motor for adjustably moving said steering column bracket with respect to said roof bracket.

15. The stowing steering arrangement for a vehicle of claim 10 further including a sensor for determining the position of said steering wheel relative to the instrument panel.

16. The stowing steering arrangement for a vehicle of claim 15 wherein said sensor is selected from the group consisting of a hall current sensor, a potentiometer sensor, and a feedback sensor.

17. A method of stowing a steering wheel in a vehicle comprising:
forming an instrument panel, a steering column having a movable shaft and a steering wheel attached to said shaft, said shaft having a stowing range of travel between about +90 mm and +110 mm from mid-line and a travel speed of between about 20 mm/sec and 40 mm/sec;
selectively retracting said wheel and extending said wheel to and from a stowed position.

18. The method of stowing a steering wheel in a vehicle of claim 17 further including a steering wheel-receiving pocket defined in said instrument panel.

19. The method of stowing a steering wheel in a vehicle of claim 17 further including a roof bracket for attachment to said instrument panel and a sleeve attached to said bracket, said a steering column shaft being movably attached to said sleeve.

20. The method of stowing a steering wheel in a vehicle of claim 17 further including a sensor for determining the position of said steering wheel relative to the instrument panel.
